(19) United States
(12) Patent Application Publication
(10) Pub. No.: US 2026/0203202 A1
(43) Pub. Date: Jul. 16, 2026

(54) OPTIMIZATION OF A DYNAMIC CODING TOOL BASED ON REAL-TIME ANALYSIS AND VISUALIZATION OF CODING METRICS

(71) Applicant: Tata Consultancy Services Limited, Mumbai (IN)

(72) Inventors: Saurabh DUBEY, Bangalore (IN); Soumya MISHRA, Bhubaneswar (IN)

(73) Assignee: Tata Consultancy Services Limited, Mumbai (IN)

(21) Appl. No.: 19/091,388

(22) Filed: Mar. 26, 2025

(30) Foreign Application Priority Data
Jan. 14, 2025 (IN) 202521003164

(51) Int. Cl. G06F 11/3698; G06F 11/362

(52) U.S. Cl. CPC G06F 11/3698; G06F 11/3624

(57) ABSTRACT

With advancement of software development industry, use of artificial intelligence (AI) is increased in the software development tools for coding assistance. However, traditional software development tools hinder an ability to fully leverage AI in software development and fail to extract meaningful insights from AI-assisted coding processes. Embodiments of the present disclosure provide a method and system for optimization of a dynamic coding tool based on real-time analysis and visualization of coding metrics. In the present disclosure, a dynamic coding tool is disclosed that provides real-time monitoring by integrating seamlessly with an integrated development environment (IDE) used by users. Once integrated, every user interaction with AI-assisted coding platforms, such as code suggestions, acceptance, and rejection of suggestions is tracked and coding metrics are determined. Further, real-time feedback and alerts based on predefined thresholds or trends are provided. This enables quick adjustments and optimizations in usage of the dynamic coding tool.

### PRIORITY CLAIM

This U.S. patent application claims priority under 35 U.S.C. § 119 to: Indian Patent Application number 202521003164, filed on 14 Jan. 2025. The entire contents of the aforementioned application are incorporated herein by reference.

### TECHNICAL FIELD

The disclosure herein generally relates to the field of coding analysis and visualization, and, more particularly, to optimization of a dynamic coding tool based on real-time analysis and visualization of coding metrics.

### BACKGROUND

With advancement of software development industry, multiple software development tools, specifically focusing on integrated development environment (IDE) extensions are designed to enhance software development lifecycle. Further, use of artificial intelligence (AI) is increased in the software development tools for coding assistance. However, traditional software development tools hinder an ability to fully leverage AI in software development and fail to extract meaningful insights from AI-assisted coding processes. Most existing tools provide basic integration with AI-assisted coding but offer limited insights into specific interactions such as AI generated suggestions acceptance or rejection. Further, the existing tools provide generic analytics.

### SUMMARY

Embodiments of the present disclosure present technological improvements as solutions to one or more of the above-mentioned technical problems recognized by the inventors in conventional systems. For example, in one embodiment, a processor implemented method is provided. The processor implemented method, comprising: receiving, via the one or more hardware processors, an input coding stream and a plurality of metadata associated with the input coding stream from one or more users in an integrated development environment for a dynamic code analysis application program, wherein the dynamic code analysis application program comprises an extension program, one or more plugin software components, and a plurality of coding tools; enabling, via the one or more hardware processors, the one or more users to perform one or more activities on the input coding stream in the integrated development environment; monitoring in real time, via the one or more hardware processors, an impact of the one or more activities on the input coding stream to identify a set of coding events in the input coding stream and obtaining a timestamp information associated with the set of coding events; modifying, via the one or more hardware processors, the input coding stream based on the set of coding events to obtain a modified input coding stream; segregating, via the one or more hardware processors, the modified input coding stream into a first set of data and a second set of data using a metadata analyzer, wherein the first set of data is obtained when one or more modifications are performed on the input coding stream by a plurality of artificial intelligence-assisted coding applications, and wherein the second set of data is obtained when one or more modifications are performed on the input coding stream by a plurality of user-assisted coding applications; obtaining, via the one or more hardware processors, a first set of metrics by processing the first set of data and the second set of data using one or more data processing techniques; aggregating, via the one or more hardware processors, the first set of metrics for a predefined time interval to obtain a second set of metrics; generating, via the one or more hardware processors, an output data pertaining to the modified input coding stream in accordance with the first set of metrics and the second set of metrics; and providing, via the one or more hardware processors, an in-depth visualization of (i) the output data, (ii) the first set of metrics and (iii) the second set of metrics to the one or more users in the integrated development environment.

In another aspect, a system is provided. The system comprising a memory storing instructions; one or more communication interfaces; and one or more hardware processors coupled to the memory via the one or more communication interfaces, wherein the one or more hardware processors are configured by the instructions to: receive an input coding stream and a plurality of metadata associated with the input coding stream from one or more users in an integrated development environment for a dynamic code analysis application program, wherein the dynamic code analysis application program comprises an extension program, one or more plugin software components, and a plurality of coding tools; enable the one or more users to perform one or more activities on the input coding stream in the integrated development environment; monitor in real time an impact of the one or more activities on the input coding stream to identify a set of coding events in the input coding stream and obtaining a timestamp information associated with the set of coding events; modify the input coding stream based on the set of coding events to obtain a modified input coding stream; segregate the modified input coding stream into a first set of data and a second set of data using a metadata analyzer, wherein the first set of data is obtained when one or more modifications are performed on the input coding stream by a plurality of artificial intelligence-assisted coding applications, and wherein the second set of data is obtained when one or more modifications are performed on the input coding stream by a plurality of user-assisted coding applications; obtain a first set of metrics by processing the first set of data and the second set of data using one or more data processing techniques; aggregate the first set of metrics for a predefined time interval to obtain a second set of metrics; generate an output data pertaining to the modified input coding stream in accordance with the first set of metrics and the second set of metrics; and provide an in-depth visualization of (i) the output data, (ii) the first set of metrics and (iii) the second set of metrics to the one or more users in the integrated development environment.

In yet another aspect, a non-transitory computer readable medium is provided. The non-transitory computer readable medium are configured by instructions for receiving an input coding stream and a plurality of metadata associated with the input coding stream from one or more users in an integrated development environment for a dynamic code analysis application program, wherein the dynamic code analysis application program comprises an extension program, one or more plugin software components, and a plurality of coding tools; enabling the one or more users to perform one or more activities on the input coding stream in the integrated development environment; monitoring in real time an impact of the one or more activities on the input coding stream to identify a set of coding events in the input coding stream and obtaining a timestamp information associated with the set of coding events; modifying the input coding stream based on the set of coding events to obtain a modified input coding stream; segregating the modified input coding stream into a first set of data and a second set of data using a metadata analyzer, wherein the first set of data is obtained when one or more modifications are performed on the input coding stream by a plurality of artificial intelligence-assisted coding applications, and wherein the second set of data is obtained when one or more modifications are performed on the input coding stream by a plurality of user-assisted coding applications; obtaining a first set of metrics by processing the first set of data and the second set of data using one or more data processing techniques; aggregating the first set of metrics for a predefined time interval to obtain a second set of metrics; generating an output data pertaining to the modified input coding stream in accordance with the first set of metrics and the second set of metrics; and providing an in-depth visualization of (i) the output data, (ii) the first set of metrics and (iii) the second set of metrics to the one or more users in the integrated development environment.

In accordance with an embodiment of the present disclosure, training steps for the trained machine learning engine comprises: the set of coding events comprises at least one of: (i) identifying one or more code suggestions, (ii) an occurrence of one or more code related vulnerabilities, (iii) a change in a plurality of code efficiency parameters, and (iv) a change in input coding stream by the dynamic code analysis application program based on the one or more activities.

In accordance with an embodiment of the present disclosure, the plurality of code efficiency parameters comprise at least one of: (i) a code vulnerability score (ii) a code coverage score, (iii) a code quality score, and (iv) a code complexity score.

In accordance with an embodiment of the present disclosure, the first set of metric represent one or more efficiency metrics that comprise at least one of: (i) an acceptance rate, (ii) a modification rate, (iii) a suggestion utilization factor, (iv) time efficiency, and (v) a normalization factor.

In accordance with an embodiment of the present disclosure, the second set of metric comprises at least a productivity metric.

In accordance with an embodiment of the present disclosure, the in-depth visualization of (i) the output data, (ii) the first set of metrics and (iii) the second set of metrics enables the one or more users to perform a comprehensive analysis and customization in real time for optimization of the plurality of coding tools in the integrated development environment.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for optimization of a dynamic coding tool based on real-time analysis and visualization of coding metrics, according to some embodiments of the present disclosure.

FIG. 2 illustrates an exemplary flow diagram illustrating a method for optimization of a dynamic coding tool based on real-time analysis and visualization of coding metrics, using the system of FIG. 1, in accordance with some embodiments of the present disclosure.

FIG. 3 provides a pictorial representation of an example hypertext markup language (HTML) report with Bar Chart Description for optimization of a dynamic coding tool based on real-time analysis and visualization of coding metrics, according to some embodiment of the present disclosure.

FIG. 4 provides a graphical representation of an example HTML Report with Productivity Impact Visualization Description for optimization of a dynamic coding tool based on real-time analysis and visualization of coding metrics, according to some embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following embodiments described herein.

With advancement of software development industry, multiple software development tools, specifically focusing on integrated development environment (IDE) extensions are designed to enhance software development lifecycle. Further, use of artificial intelligence (AI) is increased in the software development tools for coding assistance. Currently, most existing tools provide basic integration with AI-assisted coding but offer limited insights into specific interactions such as suggestion acceptance or rejection. Many tools offer generic analytics but do not cater to the specific needs of different roles (e.g., developers, managers, scrum masters). Different roles within a software development team have unique needs and perspectives, but existing tools often provide generic insights that fail to address specific concerns. For instance, a developer might need insights into AI suggestions, while a test manager might require data on how AI impacts code quality. This limits the effectiveness of these tools in supporting team-wide collaboration and decision-making. Project managers, test managers, and scrum masters need to understand development trends to make informed decisions. Without detailed insights, it becomes challenging to manage projects effectively, leading to delays and cost overruns. Current development environments and project management tools may offer analytics dashboards but often lack seamless integration of AI usage metrics into within a developer's standard workflows. This disconnect makes it challenging for teams to incorporate AI-related insights into their day-to-day decision-making processes. Further, there are several code review tools that may not distinguish between AI-generated code and manually written code effectively. Existing code review tools fail to offer detailed insights into how much of the code is AI-generated versus human-generated, leaving a blind spot in productivity measurement and code analysis. In other words, existing code review tools do not provide the necessary context to identify and evaluate AI-assisted contributions effectively. This leads to inefficiencies and potential oversights in review process which can result in lower code quality and increased development time. Traditional productivity metrics estimated by existing tools, such as lines of code or number of commits, focus on code quantity and quality but do not incorporate detailed AI-assisted coding efforts. These productivity metrics fail to capture efficiency gains or potential pitfalls introduced by AI tools. This makes it difficult for organizations to accurately measure a developer's efficiency and optimize resource allocation. In other words, organizations invest in AI coding tools but lack visibility into how these tools are being utilized and their impact on the development process. This makes it challenging to justify investment and optimize tool usage. Further, real-time feedback on AI tool usage is often limited or non-existent with the existing tools. Organizations lack tools to monitor and evaluate effectiveness of AI coding tools in real time. Without this capability, it is difficult to adjust tool usage, justify investment, or optimize developer productivity. Thus, there is a need for a tool that can enhance AI-assisted coding insights, streamline code reviews, and improve productivity metrics.

The present disclosure addresses the unresolved problems of the conventional approaches by using artificial intelligence (AI) in coding assistance and aims to improve the tracking, analysis, and optimization of AI-assisted coding processes. The present disclosure addresses challenges related to productivity measurement, code review efficiency, and development trend analysis, by providing comprehensive solutions that benefit various roles within a software development team, including developers, test managers, scrum masters, DevOps engineers, and stakeholders.

Embodiments of the present disclosure provide a method and system for optimization of a dynamic coding tool based on real-time analysis and visualization of coding metrics. In the present disclosure, a dynamic code productivity analyzer is disclosed that provides real-time monitoring by integrating seamlessly with an integrated development environment (IDE) used by a developer. Once installed, the dynamic code productivity analyzer hooks into event listeners and logging mechanisms of the IDE. This enables the dynamic coding tool to track every interaction the developer has with one or more AI-assisted coding platforms, such as code suggestions, acceptance, and rejection of suggestions. The dynamic coding tool is designed to work with multiple IDEs, capturing data in real time without interacting directly with any application programming interface (API) of AI coding tools themselves.

The system of the present disclosure captures detailed coding event data, including timestamps, types of events (e.g., acceptance or rejection), and the actual code involved. This granular tracking allows for in-depth analysis of AI tool effectiveness and developer interaction patterns. Further direct integration to IDEs provides real-time metrics and analytics within the development environment itself. This integration ensures that insights are readily available without disrupting the developer's workflow. The system of the present disclosure generates customizable reports and dashboards tailored to different roles, providing targeted insights that enhance decision-making for developers, test managers, scrum masters, and stakeholders. Further, features for marking AI-generated code and filtering code reviews accordingly are incorporated. This enhances the review process by allowing reviewers to focus on AI-generated suggestions separately from manually written code. Furthermore, new metrics are used that integrate AI-assisted coding into productivity assessments. This includes a ratio of AI-generated code and suggestion acceptance rates, providing a more comprehensive view of productivity. The system of the present disclosure offers real-time feedback and alerts based on predefined thresholds or trends, enabling quick adjustments and optimizations in AI tool usage.

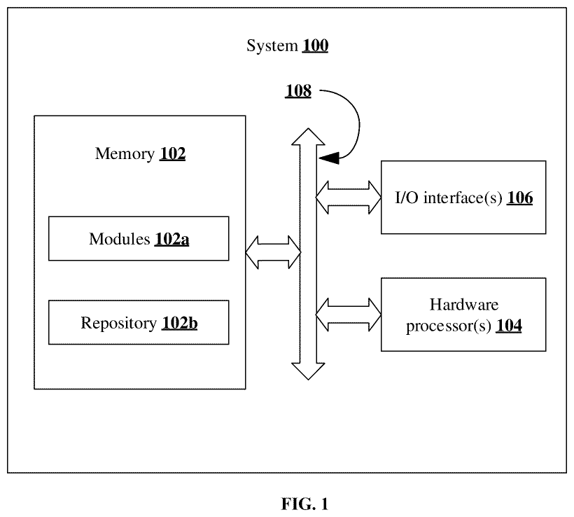

Referring now to the drawings, and more particularly to FIGS. 1 through 4, where similar reference characters denote corresponding features consistently throughout the figures, there are shown preferred embodiments and these embodiments are described in the context of the following exemplary system and/or method.

FIG. 1 illustrates an exemplary system for optimization of a dynamic coding tool based on real-time analysis and visualization of coding metrics, according to some embodiments of the present disclosure. In an embodiment, the system 100 includes or is otherwise in communication with one or more hardware processors 104, communication interface device(s) or input/output (I/O) interface(s) 106, and one or more data storage devices or memory 102 operatively coupled to the one or more hardware processors 104. The one or more hardware processors 104, the memory 102, and the I/O interface(s) 106 may be coupled to a system bus 108 or a similar mechanism.

The I/O interface(s) 106 may include a variety of software and hardware interfaces, for example, a web interface, a graphical user interface, and the like. The I/O interface(s) 106 may include a variety of software and hardware interfaces, for example, interfaces for peripheral device(s), such as a keyboard, a mouse, an external memory, a plurality of sensor devices, a printer and the like. Further, the I/O interface(s) 106 may enable the system 100 to communicate with other devices, such as web servers and external databases.

The I/O interface(s) 106 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 106 may include one or more ports for connecting a number of computing systems with one another or to another server computer. Further, the I/O interface(s) 106 may include one or more ports for connecting a number of devices to one another or to another server.

The one or more hardware processors 104 may be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In the context of the present disclosure, the expressions ‘processors’ and ‘hardware processors’ may be used interchangeably. In an embodiment, the system 100 can be implemented in a variety of computing systems, such as laptop computers, portable computer, notebooks, hand-held devices, workstations, mainframe computers, servers, a network cloud and the like.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes a plurality of modules 102a and a repository 102b for storing data processed, received, and generated by one or more of the plurality of modules 102a. The plurality of modules 102a may include routines, programs, objects, components, data structures, and so on, which perform particular tasks or implement particular abstract data types.

The plurality of modules 102a may include programs or computer-readable instructions or coded instructions that supplement applications or functions performed by the system 100. The plurality of modules 102a may also be used as, signal processor(s), state machine(s), logic circuitries, and/or any other device or component that manipulates signals based on operational instructions. Further, the plurality of modules 102a can be used by hardware, by computer-readable instructions executed by the one or more hardware processors 104, or by a combination thereof. Further, the memory 102 may include information pertaining to input(s)/output(s) of each step performed by the processor(s) 104 of the system 100 and methods of the present disclosure.

The repository 102b may include a database or a data engine. Further, the repository 102b amongst other things, may serve as a database or includes a plurality of databases for storing the data that is processed, received, or generated as a result of the execution of the plurality of modules 102a. Although the repository 102b is shown internal to the system 100, it will be noted that, in alternate embodiments, the repository 102b can also be implemented external to the system 100, where the repository 102b may be stored within an external database (not shown in FIG. 1) communicatively coupled to the system 100. The data contained within such external database may be periodically updated. For example, new data may be added into the external database and/or existing data may be modified and/or non-useful data may be deleted from the external database. In one example, the data may be stored in an external system, such as a Lightweight Directory Access Protocol (LDAP) directory and a Relational Database Management System (RDBMS). In another embodiment, the data stored in the repository 102b may be distributed between the system 100 and the external database.

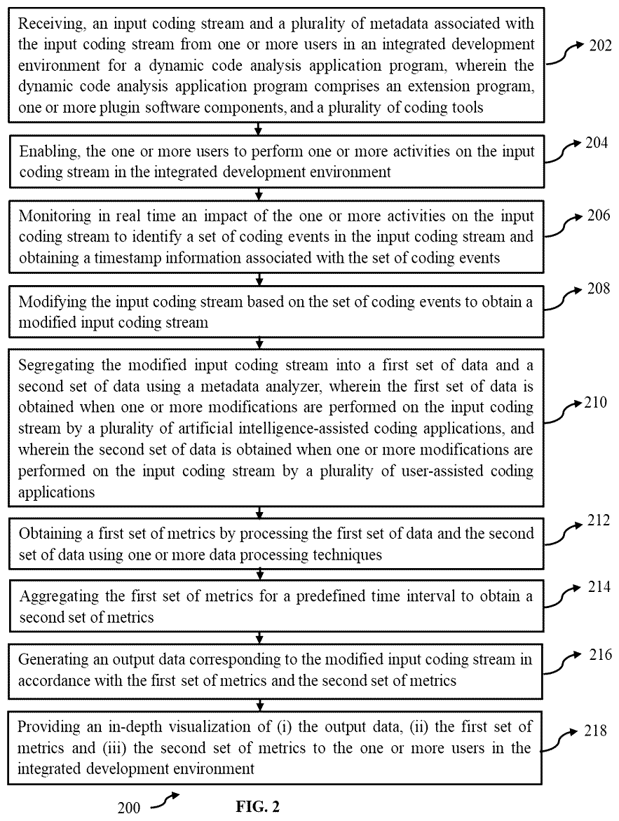

FIG. 2, with reference to FIG. 1, illustrates an exemplary flow diagram illustrating a method for optimization of a dynamic coding tool based on real-time analysis and visualization of coding metrics, according to some embodiments of the present disclosure.

Referring to FIG. 2, in an embodiment, the system(s) 100 comprises one or more data storage devices or the memory 102 operatively coupled to the one or more hardware processors 104 and is configured to store instructions for execution of steps of the method by the one or more processors 104. The steps of the method 200 of the present disclosure will now be explained with reference to components of the system 100 of FIG. 1, the flow diagram as depicted in FIG. 2, and one or more examples. Although steps of the method 200 including process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

In an embodiment, at step 202 of the present disclosure, one or more hardware processors 104 are configured to receive an input coding stream and a plurality of metadata associated with the input coding stream from one or more users in an integrated development environment for a dynamic code analysis application program. The dynamic code analysis application program comprises an extension program, one or more plugin software components, and a plurality of coding tools. A user may install the dynamic code analysis application program (interchangeably referred as dynamic code productivity analyzer or dynamic coding tool throughout the description) as an extension in their preferred integrated development environment (IDE). The one or more plugin software components are developed for the IDE using an appropriate software development kits (SDKs) from a plurality of software development kits. A set of metadata associated with the extension program is defined in a first type of file format (e.g., package.json) for the IDE and a second type of file format (e.g., plugin.xml) for the one or more plugin software components. In an embodiment, the plurality of tools comprises at least an artificial intelligence-powered coding tool. The artificial intelligence-powered coding tool may further comprise but are not limited to code review tools, code analysis tool, and/or the like. Application programming interfaces (APIs) or existing integrations provided by the plurality of tools are utilized in the present disclosure.

The extension program is interfaced with the plurality of tools (e.g., AI-assisted coding tools) to receive the input coding stream. A functionality to capture and log events (e.g., AI suggestions, acceptance, rejections) is implemented using APIs of the IDE. Furthermore, at step 204 of the present disclosure, the one or more hardware processors 104 are configured to enable the one or more users to perform one or more activities on the input coding stream in the integrated development environment. In an embodiment, the one or more activities could be but not restricted to a coding activity performed by the user.

At step 206 of the present disclosure, the one or more hardware processors 104 are configured to monitor in real time an impact of the one or more activities on the input coding stream to identify a set of coding events in the input coding stream and obtaining a timestamp information associated with the set of coding events. The set of coding events comprises at least one of: (i) identifying one or more code suggestions, (ii) an occurrence of one or more code related vulnerabilities, (iii) a change in a plurality of code efficiency parameters, and (iv) a change in input coding stream by the dynamic code analysis application program based on the one or more activities. The plurality of code efficiency parameters comprise at least one of: (i) a code vulnerability score (ii) a code coverage score, (iii) a code quality score, and (iv) a code complexity score. The code vulnerability score is determined as shown in equation (1) below:

$$Code Vulnerability Score = [ Number of Vulnerabilities Detected / Total Lines of Code ] \times 100 \qquad ( 1 )$$

The code coverage score is determined as shown in equation (2) below:

$$Code Coverage score = [ Lines of Code Covered by Tests / Total Lines of Code ] \times 100 \qquad ( 2 )$$

The code quality score is determined as shown in equation (3) below:

$$Code Quality Score = [ Number of Passed Quality Checks / Total Quality Checks ] \times 100 \qquad ( 3 )$$

The code complexity score is determined as shown in equation (4) below:

$$Code Complexity = Cyclomatic Complexity \qquad ( 4 )$$

The extension program monitors user activity and listens for the set of coding events with the help of an event handler. The set of coding events are captured including their corresponding timestamps and actual code involved. While coding, real time scanning and monitoring is triggered by a user (i.e., a logger), the dynamic code analysis application program actively monitors all coding events within the IDE and metrics related to code quality, coverage, and complexity. Also, AI-assisted coding suggestions are tracked including whether the user accepts or rejects them. Whenever the AI-assisted coding platform provides a suggestion, this event is logged along with relevant metadata such as timestamp, the code suggested, and the context within the codebase. The dynamic code analysis application program does not interact with any Copilot metric usage APIs, ensuring that data privacy and integrity are maintained. The user can customize settings, such as which metrics to track and a frequency of data collection. It is recorded whether the user accepts or rejects a suggestion. Relevant data from the IDE is extracted, such as number of lines affected by a coding event such as suggestion, complexity metrics, coverage statistics providing information on percentage of code covered by automated tests and unit tests, and timestamps when the set of coding events occur. Code vulnerabilities are detected through static analysis tools integrated into the dynamic code analysis application program which provides analysis of potential security flaws in the code. The code quality score is calculated by analyzing adherence to coding standards.

In an embodiment, at step 208 of the present disclosure, the one or more hardware processors 104 are configured to modify the input coding stream based on the set of coding events to obtain a modified input coding stream. In an embodiment, the dynamic code analysis application program tracks all modifications made to the code based on AI suggestions, whether they are accepted or rejected. For each modification, an event type (e.g., acceptance or rejection), lines of code modified, impact on one or more metrics (e.g., code coverage changes, complexity adjustments) is recorded. An analysis is performed to determine how these modifications affect overall productivity and code quality. It is tracked how the user modifies the suggested code before acceptance, giving insights into how helpful the suggestion was. In an embodiment, changes to the codebase including line additions, deletions, and modifications are captured, and these changes are tied back to the AI-generated suggestions.

At step 210 of the present disclosure, the one or more hardware processors 104 are configured to segregate the modified input coding stream into a first set of data and a second set of data using a metadata analyzer. In an embodiment, the segregation is realized to differentiate between AI-assisted suggestions and manual code entries based on analysis of metadata from the IDE's API. A functionality is developed to mark or highlight AI-generated code within the IDE and comments or special markers are used to distinguish AI-assisted suggestions. Further, several filters are implemented to allow code reviewers to focus on AI-generated or manually written code separately. The first set of data is obtained when one or more modifications are performed on the input coding stream by a plurality of artificial intelligence-assisted coding applications. Whereas the second set of data is obtained when one or more modifications are performed on the input coding stream by a plurality of user-assisted coding applications. For each modification, a final accepted code is compared to an original suggestion and extent of modification (e.g., minor edits or significant rewrites) is calculated. Further, an impact on efficiency is determined by assessing how these modifications impact overall efficiency, such as whether frequent modifications lead to delays or whether they result in higher-quality code.

At step 212 of the present disclosure, the one or more hardware processors 104 are configured to obtain a first set of metrics by processing the first set of data and the second set of data using one or more data processing techniques. The one or more data processing techniques may include but are not limited to data parsing and data structuring techniques. The first set of metric represents/includes one or more efficiency metrics that comprise at least one of: (i) an acceptance rate, (ii) a modification rate, (iii) a suggestion utilization factor, (iv) time efficiency, and (v) a normalization factor. The acceptance rate represents a percentage of suggestions accepted by the user such as developer. The modification rate represents a percentage of suggestions that were modified before acceptance. The suggestion utilization factor represents number of lines of code generated per suggestion. Time efficiency represents an average time spent per suggestion before accepting or rejecting. The normalization factor represents normalizing the acceptance rate, the modification rate, the suggestion utilization factor, and the time efficiency to account for different coding speeds, complexity of the tasks, and other environmental factors.

The first set of data and the second set of data are organized into a structured format (e.g., JavaScript Object Notation (JSON)) including timestamps, coding event types, and code snippets. The first set of data and the second set of data is stored in local files or databases. For example, JSON files or a local database are used to save coding event logs. Further, the stored JSON data is parsed and processed. Relevant metrics such as counts of acceptance and suggestions are obtained from the parsed and processed data.

Referring to FIG. 2, at step 214 of the present disclosure, the one or more hardware processors 104 are configured to aggregate the first set of metrics for a predefined time interval to obtain a second set of metrics. The second set of metric comprises at least a productivity metric. Data aggregation is performed periodically for analysis where data aggregation scripts are implemented to summarize usage metrics indicative of productivity. Productivity is calculated based on AI-assisted and manual coding efforts. Productivity is measured by combining the first set of metrics with additional factors such as an overall code output, a task completion factor, and user interaction patterns. The overall code output represents total number of lines or characters of code generated and correlated with the AI suggestions. The task completion factor represents how effectively AI-assisted suggestions help in completing coding tasks or projects. The user interaction patterns represents patterns in which users interact with AI tools, such as frequent modification of suggestions, which might indicate areas where AI assistance could be improved. By aggregating these factors, a comprehensive productivity score is provided indicating how much the AI assistance is improving or hindering the development process. The productivity metric is determined as shown in equation (5) below:

$$Productivity = [ Lines of Code Accepted / Total Lines of Code Suggested ] \times 100 \qquad ( 5 )$$

The productivity metric represents time spent on code reviews and acceptance rates and highlights improvements in efficiency and effectiveness due to the extension program. In an embodiment, new productivity metrics are determined that consider both AI-assisted and manual coding efforts. For example, AI contribution ratio and suggestion acceptance rates.

Further, at step 216 of the present disclosure, the one or more hardware processors 104 are configured to generate an output data corresponding/pertaining to the modified input coding stream in accordance with the first set of metrics and the second set of metrics. The generated output data is a processed data which is used to generate detailed reports in HTML format. These reports include visualizations such as bar charts and pie charts to present the output data clearly. The output data corresponds to HTML files with visual and textual data representations. Furthermore, at step 218 of the present disclosure, the one or more hardware processors 104 are configured to provide an in-depth visualization of (i) the output data, (ii) the first set of metrics and (iii) the second set of metrics to the one or more users in the integrated development environment. In an embodiment, the in-depth visualization of (i) the output data, (ii) the first set of metrics and (iii) the second set of metrics enables the one or more users to perform a comprehensive analysis and customization in real time for optimization of the plurality of coding tools in the integrated development environment. A visualization engine is used to creates visual representations of the output data (e.g., charts and graphs) for inclusion in final reports. Users access the generated reports through their file system or directly from the IDE.

The steps 216 and 218 are further better understood by way of following description provided as an exemplary explanation.

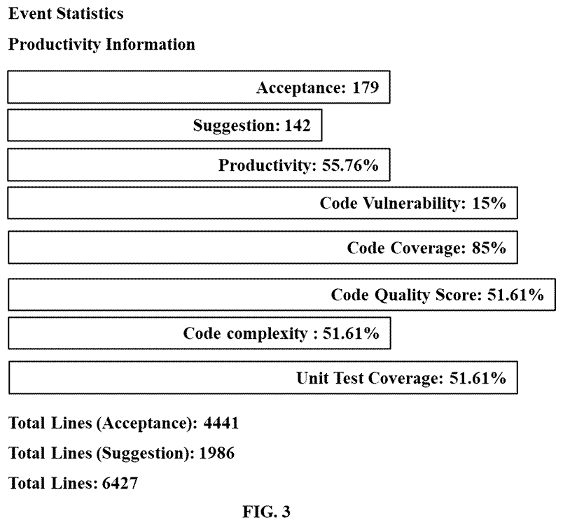

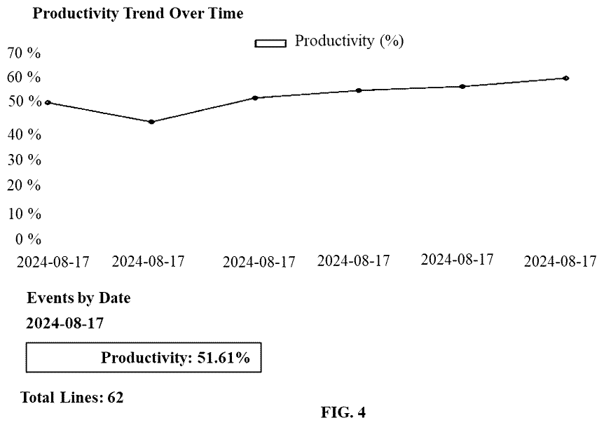

The dynamic code analysis application program (interchangeably referred as dynamic code productivity analyzer or dynamic coding tool) generates detailed reports that include (i) event statistics providing counts of accepted and rejected suggestions, (ii) productivity trends providing line charts showing productivity over time, (iii) code quality analysis providing details on metrics like code vulnerability, code coverage, code complexity, and code quality score, and (iv) comparison metrics illustrating how current productivity compares to previous periods. With insights into vulnerabilities, coverage, and complexity, users can make informed decisions to improve code quality. The detailed reports are visualized in an easy-to-understand format, with charts, graphs, and bar visuals using or more known in the art libraries. The first and second set of metric are visualized effectively in reports and dashboards. Productivity analysis is done by creating advanced reports that analyses productivity trends over time, considering the impact of AI tools. Users gain a deeper understanding of how AI-assisted coding affects their overall development process. In an embodiment, the detailed report could be a Hypertext Markup Language (HTML) report. In an embodiment, a user-friendly dashboard is integrated within the IDE to display metrics and reports such as the number of AI suggestions, acceptance rates, and code generated. This integration ensures that developers and managers can access these insights without leaving their development environment. IDE APIs are used to embed custom views and analytics. Using, the detailed reports and dashboard representations, performance changes and productivity improvements attributable to AI tool usage are tracked. The generated reports and dashboards are customizable and tailored to different roles (e.g., developers, managers, test leads). Customization enables users to focus on specific metrics that matter most to their workflow. In an embodiment, an analytics engine is provided that processes real-time data and provides feedback on AI tool effectiveness. Users can monitor and improve their productivity based on real-time data resulting in enhanced productivity. It is ensured that AI-related metrics are accessible within the developer's workflow, making it easier to use these insights for real-time decision-making and adjustments. Further, a notification sub-system is implemented to alert users of significant trends or anomalies in AI-assisted tool usage. For example, a development teams in an organization receive immediate alerts when certain thresholds or trends are detected, such as a high rejection rate of suggestions. In such cases, teams can quickly adjust their use of the AI tool or provide additional training to address any issues. Further, filtering options are implemented to allow users to view data relevant to their specific needs. FIG. 3 provides a pictorial representation of an example hypertext markup language (HTML) Report with Bar Chart Description for optimization of a dynamic coding tool based on real-time analysis and visualization of coding metrics, according to some embodiment of the present disclosure. As shown in FIG. 3, the bar chart visualizes the number of acceptance and suggestion events and separate bars are used for acceptance and suggestion events. This provides a clear comparison of how often each type of event occurs. The HTML Report shown in FIG. 3 is styled with CSS to enhance readability and presentation. In an embodiment, styles for the bar chart, headers, and textual content are provided during visualization of the HTML report. FIG. 4 provides a graphical representation of an example HTML Report with Productivity Impact Visualization Description for optimization of a dynamic coding tool based on real-time analysis and visualization of coding metrics, according to some embodiment of the present disclosure. FIG. 4 illustrates how the extension program affects productivity metrics over time by comparing key performance indicators before and after its usage such as time spent on code reviews and acceptance rates. This highlights improvements in efficiency and effectiveness due to the extension program.

The written description describes the subject matter herein to enable any person skilled in the art to make and use the embodiments. The scope of the subject matter embodiments is defined herein and may include other modifications that occur to those skilled in the art. Such other modifications are intended to be within the scope of the present disclosure if they have similar elements that do not differ from the literal language of the embodiments or if they include equivalent elements with insubstantial differences from the literal language of the embodiments described herein.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated herein by the following claims.

What is claimed is:

1. A processor implemented method, comprising:
receiving, via the one or more hardware processors, an input coding stream and a plurality of metadata associated with the input coding stream from one or more users in an integrated development environment for a dynamic code analysis application program, wherein the dynamic code analysis application program comprises an extension program, one or more plugin software components, and a plurality of coding tools;
enabling, via the one or more hardware processors, the one or more users to perform one or more activities on the input coding stream in the integrated development environment;
monitoring in real time, via the one or more hardware processors, an impact of the one or more activities on the input coding stream to identify a set of coding events in the input coding stream and obtaining a timestamp information associated with the set of coding events;
modifying, via the one or more hardware processors, the input coding stream based on the set of coding events to obtain a modified input coding stream;
segregating, via the one or more hardware processors, the modified input coding stream into a first set of data and a second set of data using a metadata analyzer, wherein the first set of data is obtained when one or more modifications are performed on the input coding stream by a plurality of artificial intelligence-assisted coding applications, and wherein the second set of data is obtained when one or more modifications are performed on the input coding stream by a plurality of user-assisted coding applications;
obtaining, via the one or more hardware processors, a first set of metrics by processing the first set of data and the second set of data using one or more data processing techniques;
aggregating, via the one or more hardware processors, the first set of metrics for a predefined time interval to obtain a second set of metrics;
generating, via the one or more hardware processors, an output data pertaining to the modified input coding stream in accordance with the first set of metrics and the second set of metrics; and
providing, via the one or more hardware processors, an in-depth visualization of (i) the output data, (ii) the first set of metrics and (iii) the second set of metrics to the one or more users in the integrated development environment.

2. The processor implemented method of claim 1, wherein the set of coding events comprises at least one of: (i) identifying one or more code suggestions, (ii) an occurrence of one or more code related vulnerabilities, (iii) a change in a plurality of code efficiency parameters, and (iv) a change in input coding stream by the dynamic code analysis application program based on the one or more activities.

3. The processor implemented method of claim 1, wherein the plurality of code efficiency parameters comprise at least one of: (i) a code vulnerability score (ii) a code coverage score, (iii) a code quality score, and (iv) a code complexity score.

4. The processor implemented method of claim 1, wherein the first set of metric represent one or more efficiency metrics that comprise at least one of: (i) an acceptance rate, (ii) a modification rate, (iii) a suggestion utilization factor, (iv) time efficiency, and (v) a normalization factor.

5. The processor implemented method of claim 1, wherein the second set of metric comprises at least a productivity metric.

6. The processor implemented method of claim 1, wherein the in-depth visualization of (i) the output data, (ii) the first set of metrics and (iii) the second set of metrics enables the one or more users to perform a comprehensive analysis and customization in real time for optimization of the plurality of coding tools in the integrated development environment.

7. A system comprising:
a memory storing instructions;
one or more communication interfaces; and
one or more hardware processors coupled to the memory via the one or more communication interfaces, wherein the one or more hardware processors are configured by the instructions to:
receive an input coding stream and a plurality of metadata associated with the input coding stream from one or more users in an integrated development environment for a dynamic code analysis application program, wherein the dynamic code analysis application program comprises an extension program, one or more plugin software components, and a plurality of coding tools;
enable the one or more users to perform one or more activities on the input coding stream in the integrated development environment;
monitor in real time an impact of the one or more activities on the input coding stream to identify a set of coding events in the input coding stream and obtaining a timestamp information associated with the set of coding events;
modify the input coding stream based on the set of coding events to obtain a modified input coding stream;
segregate the modified input coding stream into a first set of data and a second set of data using a metadata analyzer, wherein the first set of data is obtained when one or more modifications are performed on the input coding stream by a plurality of artificial intelligence-assisted coding applications, and wherein the second set of data is obtained when one or more modifications are performed on the input coding stream by a plurality of user-assisted coding applications;
obtain a first set of metrics by processing the first set of data and the second set of data using one or more data processing techniques;
aggregate the first set of metrics for a predefined time interval to obtain a second set of metrics;
generate an output data pertaining to the modified input coding stream in accordance with the first set of metrics and the second set of metrics; and
provide an in-depth visualization of (i) the output data, (ii) the first set of metrics and (iii) the second set of metrics to the one or more users in the integrated development environment.

8. The system of claim 7, wherein the set of coding events comprises at least one of: (i) identifying one or more code suggestions, (ii) an occurrence of one or more code related vulnerabilities, (iii) a change in a plurality of code efficiency parameters, and (iv) a change in input coding stream by the dynamic code analysis application program based on the one or more activities.

9. The system of claim 7, wherein the plurality of code efficiency parameters comprise at least one of: (i) a code vulnerability score (ii) a code coverage score, (iii) a code quality score, and (iv) a code complexity score.

10. The system of claim 7, wherein the first set of metric represent one or more efficiency metrics that comprise at least one of: (i) an acceptance rate, (ii) a modification rate, (iii) a suggestion utilization factor, (iv) time efficiency, and (v) a normalization factor.

11. The system of claim 7, wherein the second set of metric comprises at least a productivity metric.

12. The system of claim 7, wherein the in-depth visualization of (i) the output data, (ii) the first set of metrics and (iii) the second set of metrics enables the one or more users to perform a comprehensive analysis and customization in real time for optimization of the plurality of coding tools in the integrated development environment.

13. One or more non-transitory machine-readable information storage mediums comprising one or more instructions which when executed by one or more hardware processors cause:
receiving an input coding stream and a plurality of metadata associated with the input coding stream from one or more users in an integrated development environment for a dynamic code analysis application program, wherein the dynamic code analysis application program comprises an extension program, one or more plugin software components, and a plurality of coding tools;
enabling the one or more users to perform one or more activities on the input coding stream in the integrated development environment;
monitoring in real time, an impact of the one or more activities on the input coding stream to identify a set of coding events in the input coding stream and obtaining a timestamp information associated with the set of coding events;
modifying the input coding stream based on the set of coding events to obtain a modified input coding stream;
segregating the modified input coding stream into a first set of data and a second set of data using a metadata analyzer, wherein the first set of data is obtained when one or more modifications are performed on the input coding stream by a plurality of artificial intelligence-assisted coding applications, and wherein the second set of data is obtained when one or more modifications are performed on the input coding stream by a plurality of user-assisted coding applications;
obtaining a first set of metrics by processing the first set of data and the second set of data using one or more data processing techniques;
aggregating the first set of metrics for a predefined time interval to obtain a second set of metrics;
generating, an output data pertaining to the modified input coding stream in accordance with the first set of metrics and the second set of metrics; and
providing, an in-depth visualization of (i) the output data, (ii) the first set of metrics and (iii) the second set of metrics to the one or more users in the integrated development environment.

14. The one or more non-transitory machine-readable information storage mediums of claim 13, wherein the set of coding events comprises at least one of: (i) identifying one or more code suggestions, (ii) an occurrence of one or more code related vulnerabilities, (iii) a change in a plurality of code efficiency parameters, and (iv) a change in input coding stream by the dynamic code analysis application program based on the one or more activities.

15. The one or more non-transitory machine-readable information storage mediums of claim 13, wherein the plurality of code efficiency parameters comprise at least one of: (i) a code vulnerability score (ii) a code coverage score, (iii) a code quality score, and (iv) a code complexity score.

16. The one or more non-transitory machine-readable information storage mediums of claim 13, wherein the first set of metric represent one or more efficiency metrics that comprise at least one of: (i) an acceptance rate, (ii) a modification rate, (iii) a suggestion utilization factor, (iv) time efficiency, and (v) a normalization factor.

17. The one or more non-transitory machine-readable information storage mediums of claim 13, wherein the second set of metric comprises at least a productivity metric.

18. The one or more non-transitory machine-readable information storage mediums of claim 13, wherein the in-depth visualization of (i) the output data, (ii) the first set of metrics and (iii) the second set of metrics enables the one or more users to perform a comprehensive analysis and customization in real time for optimization of the plurality of coding tools in the integrated development environment.
